(19) United States
(12) Patent Application Publication
(10) Pub. No.: US 2008/0318108 A1
(43) Pub. Date: Dec. 25, 2008

(54) Solid Electrolyte, Membrane and Electrode Assembly, and Fuel Cell

(75) Inventors: Masashi Kaneko, Minami-ashigara-shi (JP); Masayuki Harada, Minami-ashigara-shi (JP); Kimiatsu Nomura, Ashigarakami-gun (JP); Takayuki Itou, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/766,810

(22) Filed: Jun. 22, 2007

(51) Int. Cl. H01M 8/10

(52) U.S. Cl. 429/33

(57) ABSTRACT

A solid electrolyte having an aromatic ring, wherein a sulfonic acid group represented by the following formula (1) bonds to the aromatic ring.

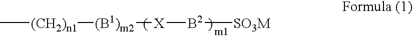

wherein B¹ and B² each independently represents a linking group, at least one of B¹ and B² is a fluorinated alkylene group, X represents a group containing a hetero atom, M represents a cation, m1 represents an integer of 1 or more, m2 represents 0 or 1 and n1 represents an integer of 1 to 20.

The solid electrolyte exhibits a high ion conductivity.

### BACKGROUND OF THE INVENTION

1. Field of the Invention

The present invention relates to a fuel cell that directly uses pure hydrogen, methanol, ethanol, dimethyl ether, or reformed hydrogen from methanol or fossil fuels as a fuel, and air or oxygen as an oxidizing reagent, and particularly to materials and a membrane and electrode assembly used in a solid polymer fuel cell, and a fuel cell.

2. Description of the Related Art

In these years, a fuel cell, which is can be utilized as a power source for next generation, is actively studied, and a solid electrolyte, which is an element thereof as a proton conductive material, is also actively studied.

In general, as a proton conductive material, a perfluorocarbon sulfonic acid film as represented by Nafion (registered trademark) is used. However, it has not sufficient proton conductivity yet. But, increase in an amount of sulfonic acid group in the polymer structure for the purpose of enhancing the proton conductivity results in decrease in mechanical strength and solubilization in an aqueous solvent. Further, it has such problem that it softens under high temperature conditions (100° C. or more) to result in decrease in the proton conductivity, which makes use of Nafion® difficult at high temperature regions (100-140° C. or more). In addition, there also remains such problems that a monomer to be used is relatively expensive and the complex production method pushes up the production cost.

There are many examples of developing a solid electrolyte using a polymer raw material with a high rigidity. On the other hand, in these years, a solid electrolyte, which uses a resin material with a high solvent resistance among polymer raw materials, has been studied. For example, there are disclosures about a solid electrolyte mainly employing sulfonated polyether ether ketone, sulfonated polysulfone or sulfonated polyether ketone in JP-A-6-49202, JP-A-6-93114, JP-A-8-20716, JP-A-9-245818 and JP-A-10-21943. However, in all of these solid electrolytes, since a sulfonic acid group directly bonds to an aromatic ring in the polymer main chain, there is such problem that the sulfonic acid group is gradually detached due to a high operation temperature to result in lowering in battery performance. Further, since the sulfonic acid group bonds directly to the polymer main chain, distance between the main chain as a hydrophobic site and the sulfonic acid group as a hydrophilic site is short to lead to absorption of water molecules beyond necessity, thereby resulting in such problem that a low introduction amount of the sulfonic acid group makes the compound soluble in an aqueous solvent.

In Japanese Patent No. 3607862, a solid electrolyte is manufactured by bonding a sulfonic acid group, via an alkyl group, to an aromatic ring in the polymer main chain synthesized by polycondensation. The method aims to enhance the proton conductivity and mechanical strength by bonding a sulfonic acid group to the main chain via a methylene group and thus separating the hydrophobic site of the main chain from the hydrophilic site of a side chain having the sulfonic acid group with a relatively large distance. However, as it now stands in actual, since the reaction efficiency is very low, only a small amount of sulfonic acid groups are introduced and the hydrophilic site of the side chain having the sulfonic acid group is not sufficiently separated from the hydrophobic site of the main chain.

As mentioned above, a solid electrolyte in which a sulfonic acid group bonds to the aromatic ring in the polymer main chain via an alkyl group causes extreme decrease of the proton conductivity under high temperature and low humidity on its properties.

In JP-A-2005-314452, a solid electrolyte is manufactured by bonding a sulfonic acid group, via a fluorine-substituted alkyl group, to an aromatic ring in the polymer main chain. However, this method is presumed that since the polymer therein has a side chain structure containing an aromatic ring and a fluorine-substituted alkyl group, those groups are mixed among the main chin in high density, and thus, the channel of proton is not sufficiently constructed. Therefore, the proton conductivity is not raised in proportion to the amount of a sulfonic acid group.

Further, when an electrode assembly (MEA) with the above solid electrolyte, which mainly comprises sulfonation polyetheretherketone, sulfonation polysulfone or sulfonation polyetherketone, is manufactured, a polymer same or similar as the polymer used in solid electrolyte is preferably used as the binder for a catalyst layer in order to enhance the adhesiveness. The similar problem to the above occurs.

### SUMMARY OF THE INVENTION

It is an object of the present invention to solve the above-described problems, and to provide a solid electrolyte having a high ion conductivity.

It was found that, by bonding a sulfonic acid group to an aromatic ring in the polymer main chain not directly but via a fluorination alkylene chain containing a hetero atom, the sulfonic acid group is not detached at high operation temperatures, thereby not leading to lowering in the battery performance even if in the condition of high temperature or high humidity as a property of superstrong acid.

Further, we found that, by bonding a sulfonic acid group via a fluorination alkylene chain containing a hetero atom, the solid electrolyte does not become water-soluble when the amount of the sulfonic acid group is increased more than ever in order to raise the proton conductivity, to enhance the battery performance.

In addition, we found that use of the solid electrolyte of the invention as a binder of a catalyst layer, as being the same material thereof, can advance the battery performance because it enhances electrochemical adhesion between the solid electrolyte and the catalyst layer. In addition, we found that, by bonding a sulfonic acid group to an aromatic ring in the polymer main chain via a fluorination alkylene chain containing a hetero atom, the distance between the polymer main chains is widened with the alkylene chain to raise the diffusion performance for oxygen and hydrogen as fuels in a catalyst layer, thereby completing the invention. Specifically, the object was achieved according to the following means.

(1) A solid electrolyte having an aromatic ring in a main chain, wherein a sulfonic acid group represented by the following formula (1) bonds to the aromatic ring:

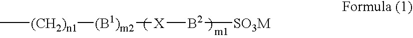

wherein B¹ and B² each independently represents a linking group, at least one of B¹ and B² is a fluorinated alkylene group, X represents a group containing a hetero atom, M represents a cation, m1 represents an integer of 1 or more, m2 represents 0 or 1, and n1 represents an integer of 1 to 20.

(2) The solid electrolyte according to (1), wherein X in the formula (1) includes an oxygen atom, a sulfur atom or a nitrogen atom.

(3) The solid electrolyte according to (1) or (2), wherein m1 in the formula (1) represents an integer of 1 to 6.

(4) The solid electrolyte according to any one of (1) to (3), wherein the B¹ in the formula (1) is a linking group having 0 to 100 carbon atoms selected from the group consisting of an alkylene group, a halogen-substituted alkylene group, an alkyl-substrated alkylene group, an arylene group, a halogen-substituted arylene group, an alkyl-substrated arylene group, an alkenylene group, a halogen-substituted alkenylene group, an alkyl-substrated alkenylene group, an alkynylene group, an amide group, an ester group, a sulfonamide group, a sulfonic acid ester group, an ureido group, a sulfonyl group, a sulfinyl group, a thioether group, an ether group, a carbonyl group, a heteryllene group, and a group constituted by combining 2 or more of these.

(5) The solid electrolyte according to any one of (1) to (4), wherein the B² in the formula (1) is a linking group having 0 to 100 carbon atoms selected from the group consisting of a halogen-substituted alkylene group, a halogen-substituted arylene group, a halogen-substituted alkenylene group, and a group constituted by combining 2 or more of these.

(6) The solid electrolyte according to any one of (1) to (5), wherein the main chain comprises at least one type of repeating unit represented by the following formula (2):

—R¹—X— Formula (2)

wherein R¹ represents any one of structures represented by formulae (6)-(25) below:

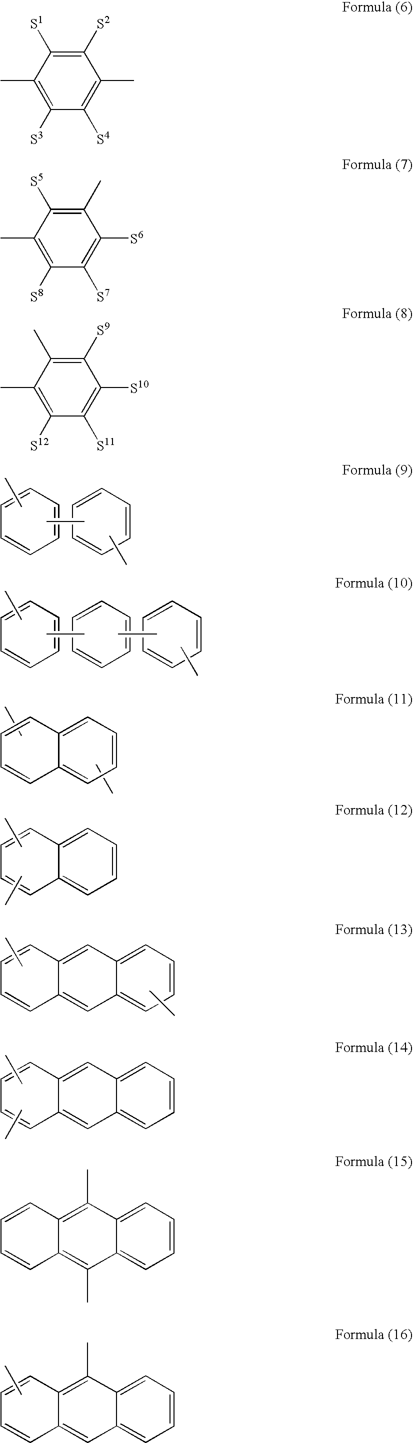

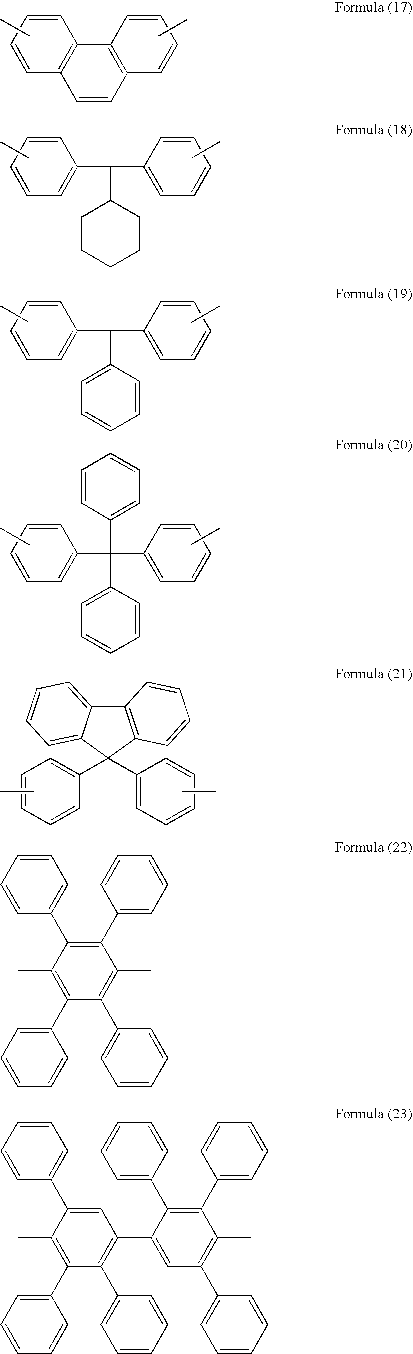

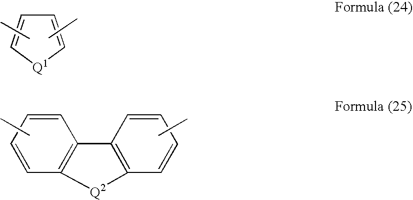

wherein S¹-S¹² in the formulae (6)-(8) each independently represents a hydrogen atom or a substitution group; Q¹ in the formula (24) represents —O— or —S—; and Q² in the formula (25) represents —O—, —CH₂—, —CO— or —NH₂—; X represents a single bond, —C(R⁵R⁶)—, —O—, —S—, —CO—, —SO— —SO₂—, or a combination of 2 or more of these, wherein R⁵ and R⁶ each independently represents a hydrogen atom, an alkyl group, an alkenyl group, an aryl group or a halogen-substituted alkyl group.

(7) The solid electrolyte according to any one of (1) to (6), wherein the solid electrolyte is in the form of a film.

(8) A membrane and electrode assembly comprising the solid electrolyte as described in (7) and a gas diffusion electrode consisting of a pair of electrodes sandwiching the solid electrolyte therebetween.

(9) The membrane and electrode assembly according to (8), wherein the gas diffusion electrode is an electrode in which a fine particle of catalyst metal is carried on the surface of a conductive material comprising a carbon material by a binder.

(10) The membrane and electrode assembly described in (9), wherein the binder includes the solid electrolyte described in any one of (1) to (7).

(11) A fuel cell including the membrane and electrode assembly described in any one of (8) to (10).

(12) The fuel cell described in (11) further including a pair of gas-impermeable separators that are arranged so as to sandwich the gas diffusion electrode.

(13) The fuel cell described in (12) further including a pair of current collectors arranged between the solid electrolyte and the separator.

### BRIEF DESCRIPTION OF THE DRAWINGS

FIG. 1 is a schematic cross-sectional view showing a constitution of a catalyst electrode-bonding film employing the solid electrolyte of the invention.

FIG. 2 is a schematic cross-sectional view showing an example of the structure of the fuel cell according to the invention.

### BEST MODE FOR CARRYING OUT THE INVENTION

Hereinafter, contents of the present invention will be described in detail. In this connection, in the specification of the present application, “-” is used in such meaning that numeric values described at before and after it are included as the lower limit and the upper limit, respectively. Further, “an A-substituted B group” means a B group substituted by an A. For example, a halogen-substituted alkyl group means an alkyl group substituted by a halogen atom. In addition, “a group” which is not clearly recited to be to have a substituent group, may have a substituent group without departing the object of the present intention.

The invention features that the sulfonic acid group represented by the formula (1) bonds to an aromatic ring. Particularly, it is preferable that the aromatic structure is the main chain and in which the aromatic ring bonds to the sulfonic acid group represented by the formula (1). The solid electrolyte of the invention can be preferably used for a fuel cell.

The formula (1) is a sulfonic acid group which contains a hetero atom and has a fluorination alkylene group.

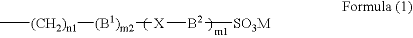

wherein B¹ and B² each independently represents a linking group, at least one of B¹ and B² is a fluorinated alkylene group, X represents a group containing a hetero atom, M represents a cation, m1 represents an integer of 1 or more, m2 represents 0 or 1, and n1 represents an integer of 1 to 20.

In the formula (1), B¹ and B² each independently represents a linking group, and at least one of B¹ and B² contains a fluorinated alkylene group. Preferably, at least B² contains a fluorinated alkylene group.

The linking group for B¹ preferably represents a linking group selected from the group consisting of alkylene group, a halogen-substituted alkylene group, an alkyl-substrated alkylene group, an arylene group, a halogen-substituted arylene group, an alkyl-substrated arylene group, an alkenylene group, a halogen-substituted alkynylene group, an alkyl-substrated alkynylene group, an alkynylene group, an amide group, an ester group, a sulfonamide group, a sulfonic acid ester group, an ureido group, a sulfonyl group, a sulfinyl group, a thioether group, an ether group, a carbonyl group, a heteryllene group, and a group constituted by combining 2 or more of these. The B¹ preferably has a linking group having 0-100 carbon atoms, more preferably 1-50 carbon atoms, and further more preferably 1-30.

The linking group as B¹ more preferably represents a linking group having 0-100 carbon atoms (preferably 1-20 carbon atoms) selected from an alkylene group (preferably an alkylene group having 1-20 carbon atoms such as a methylene group, an ethylene group, a methylethylene group, a propylene group, a methylpropylene group, a butylene group, a pentylene group, a hexylene group and an octylene group), a halogen-substituted alkylene group (preferably a halogen-substituted alkylene group having 1-20 carbon atoms such as a difluoromethylene, tetrafluoroethylene, difluoroethylene, difluoropropylene, tetrafluoropropylene, hexafluorohexylene, tetrafluorohexylene, dichloromethylene),an arylene group (preferably an arylene group having 6-26 carbon atoms such as a 1,2-phenylene group, a 1,3-phenylene group, a 1,4-phenylene group, a 4-phenylenemethylene group and a 1,4-naphthylene group), an halogen-substituted arylene group (preferably an halogen-substrated arylene group having 6-26 carbon atoms such as 2,3,5,6-tetrafluoro-1,4-phenylene group, 2,6-difluoro-1,4-phenylene group, 2,3,5,6-tetrachloro-1,4-phenylene group, 3,4,5,6-tetrabromophenylene group), an alkenylene group (preferably an alkenylene group having 2-20 carbon atoms such as an ethenylene group, a propenylene group and a butadienylene group), a halogen-substituted alkenylene group (preferably a halogen-substituted alkenylene group having 2-20 carbon atoms such as difluoroethenylene group, tetrafluoropropenylene group, dichloroethenylene group), an alkynylene group (preferably an alkynylene group having 2-20 carbon atoms such as an ethynylene group and a propynylene group), an amide group, an ester group, a sulfonamide group, a sulfonic acid ester group, an ureido group, a sulfonyl group, a sulfynyl group, a thioether group, an ether group, a carbonyl group, a heteryllene group (preferably a heteryllene group having 1-26 carbon atoms such as a 6-chloro-1,3,5-triagile-2,4-diyl group, a pyrimidine-2,4-diyl group, a quinoxaline-2,3-diyl group), and a combination of 2 or more of these. Among these, an alkylene group, a halogen-substituted alkylene group, an alkynylene group, a halogen-substituted alkynylene group, an arylene group, a halogen-substituted arylene group, a thioether group, and an ether group is more preferable, and an alkylene group, a halogen-substituted alkylene group, an arylene group, a halogen-substituted arylene group, a thioether group, and an ether group is further more preferable.

The linking group as B² more preferably represents a linking group having 0-100 carbon atoms (preferably 1-20 carbon atoms) selected from a halogen-substituted alkylene group (preferably a halogen-substituted alkylene group having 1-20 carbon atoms such as a difluoromethylene group, a tetrafluoroethylene group, a difluoroethylene group, a difluoropropylene group, a tetrafluoropropylene group, a hexafluorohexylene group, a tetrafluorohexylene group, a dichloromethylene group), a halogen-substituted arylene group (preferably a halogen-substituted arylene group having 6-26 carbon atoms such as 2,3,5,6-tetrafluoro-1,4-phenylene group, 2,6-difluoro-1,4-phenylene group, 2,3,5,6-tetrachloro-1,4-phenylene group, 3,4,5,6-tetrabromophenylene group), an halogen-substituted alkynylene group (preferably a halogen-substituted alkynylene group having 2-20 carbon atoms such as difluoroethenylene group, tetrafluoropropenylene group, dichloroethenylene group), and a combination of 2 or more of these. Among these, a halogen-substituted alkylene group and a halogen-substituted arylene group is more preferable.

In the formula (1), X is a group containing a hetero atom, that is, it contains 1 or 2 or more hetero atoms. X may be constituted of only a hetero atom or of a hetero atom and other atoms. Preferably, it is a group constituted of only a hetero atom. Example of the hetero atom in the present invention includes O, S and N, preferably O and S. Example of X includes —O—, —S—, —SO— and —SO₂—, preferably —O—, —S— and —SO₂—, more preferably —S— and —O—, further preferably —O—.

In the formula (1), M represents a cation, and is preferably selected from the group consisting of a proton, alkali metal (lithium, sodium, potassium) cations, alkali earth metal (potassium, strontium, barium) cations, quaternary ammonium (trimethyl ammonium, triethylammonium, tributylammonium, benzyltrimethylammonium) cations, and protonated organic basic groups (triethylamine, pyridine, methylimidazole, morpholine, tributylammonium, tris (2-hydroxyethyl)amine), and is more preferably a proton.

In the formula (1), m1 is preferably an integer of 1-6, more preferably an integer of 1-3, further preferably an integer of 1 or 2.

In the formula (1), n is an integer of 1-20, preferably an integer of 1-12, more preferably an integer of 1-6, further preferably an integer of 1 or 2.

When the group represented by the formula (1) forms a salt, the proton of the acid residue is preferably substituted with a cation listed below. The substitution ratio (cation/acid residue) is 0-1, and preferably 0.1 or less when the solid electrolyte is used as a solid electrolyte for a fuel cell, although there is no particular restriction during the synthesis process of the solid electrolyte. Examples of the cation for forming a salt include preferably alkali metal (lithium, sodium, potassium) cations, alkali earth metal (potassium, strontium, barium) cations, quaternary ammonium (trimethylammonium, triethylammonium, tributylammonium, benzyltrimethylammonium) cations and protonated organic basic groups (triethylamine, pyridine, methylimidazole, morpholine, tributylammonium, tris(2-hydroxyethyl)amine), more preferably alkali metal cations and ammonium cations, and particularly preferably alkali metal cations.

Examples of the group represented by the formula (1) will be shown below, but the invention is not restricted to these.

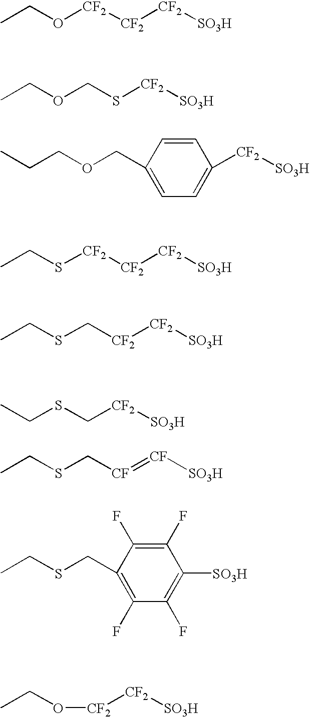

The main chain of the solid electrolyte that is employed in the invention has preferably at least one type of repeating unit represented by the formula (2), and is more preferably constituted of the repeating unit represented by the formula (2). Description will be given below about the formula (2).

—R¹—X— Formula (2)

wherein R¹ is any of structures represented by following formulae (6)-(25), and structures (6)-(9) are preferable.

Bonding groups of (9)-(14), (17)-(21), (23) and (24) may bond at any position, but, preferably, adjacent groups bond so that they are in para positions with each other.

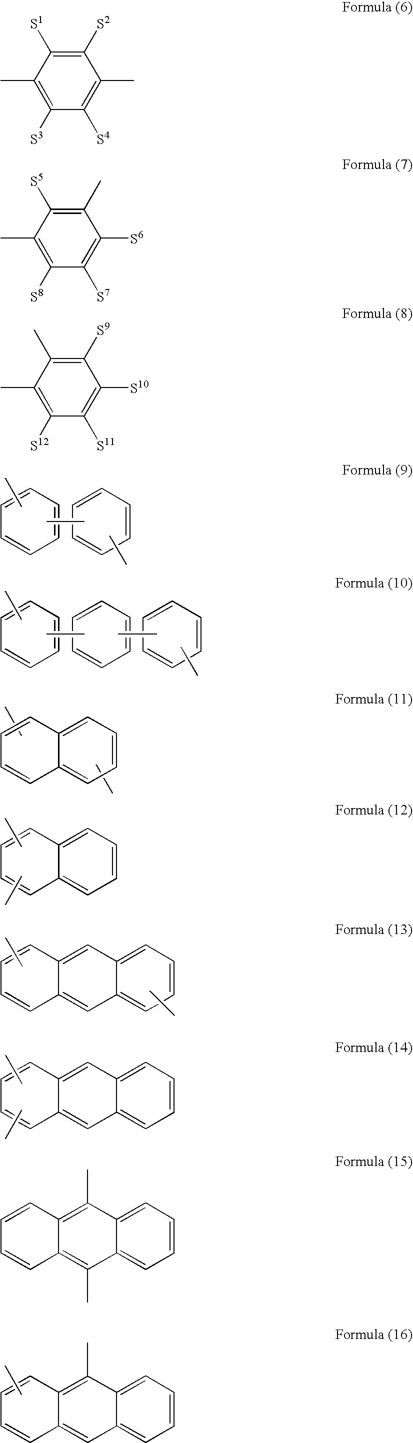

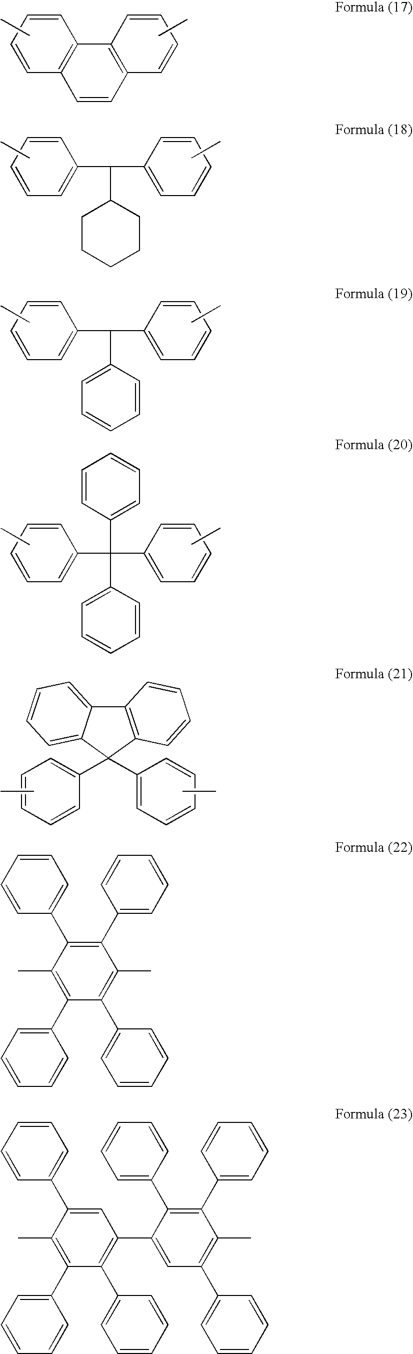

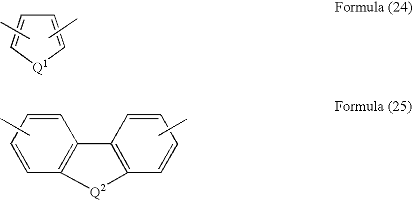

In formulae (6)-(8), S¹-S¹² each independently represents a hydrogen atom or a substituent. Examples of the substituent include an alkyl group, a halogen-substituted alkyl group, an aryl group, a halogen-substituted aryl group, an alkynyl group, a halogen-substituted alkynyl group, a hydroxyl group, a carbonyl group, a sulfonic acid, a carboxylic group, a phosphoric acid group, a thioether group and an ether group.

In the formula (24), Q¹ represents —O— or —S—.

In the formula (25), Q² represents —O—, —CH₂—, —CO— or —NH—.

X represents a single bond, —C(R⁵R⁶)—, —O—, —S—, —CO—, —SO— —SO₂—, or a combination of 2 or more of these, wherein R⁵ and R⁶ each independently represents a hydrogen atom, an alkyl group (for example, a methyl group, an ethyl group, a benzyl group or the like), an alkenyl group, an aryl group or a halogen-substituted alkyl group (for example, a trifluoromethyl group or pentafluoroethyl group), and more preferably —C(CH₃)₂—, —C(CF₃)₂—, —O—, —S—, —CO— or —SO₂—.

Each of the repeating units represented by the formula (2) may be contained by one type alone, or by 2 or more types.

Examples of the main chain of the polymer compound that is employed in the invention will be shown below, but the invention is not restricted to these. Of the following, it is preferable to contain at least one of (3-1) to (3-7).

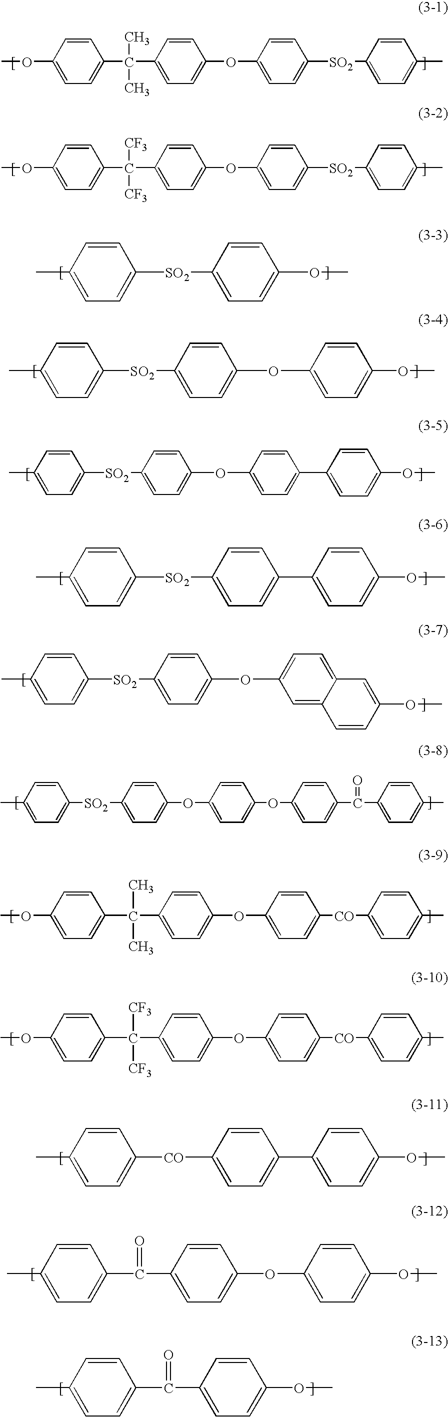

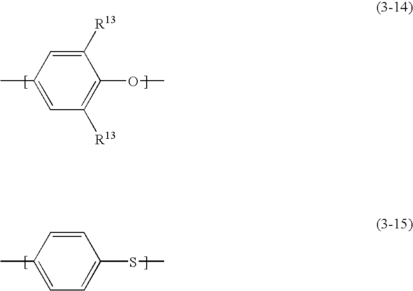

Here, R¹³ and R¹⁴ each independently represents an alkyl group having 1-10 carbon atoms or a phenyl group having 6-12 carbon atoms.

A sulfonic acid group may bond, via a group containing a sulfur atom, to any site of the aromatic ring in the main chain, but preferably to an aromatic ring constituting bisphenol or an aromatic ring bonded with an electron attracting group.

In the invention, as an example of a method for synthesizing a polymer compound to which a sulfonic acid group is not introduced yet, there can be mentioned a production method in which a compound represented by the formula (26) below is polymerized (preferably polycondensed) with a compound represented by the formula (27) below.

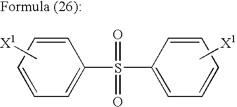

wherein X¹ represents a halogen atom (such as a fluorine atom and chlorine atom) or a nitro group. Two X¹s may be identical to or different from each other.

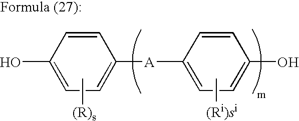

wherein A has the same meaning and preferable range as those for X in the above-described formula (2). m is 0, 1 or 2. R and Rⁱ each independently represents an alkyl group having 1-10 carbon atoms, and is preferably a methyl group or an ethyl group. s and sⁱ each independently represents 0 or an integer of 1-4, and is preferably 0 or 1.

Specific examples of the compound represented by the formula (26) include the following compounds.

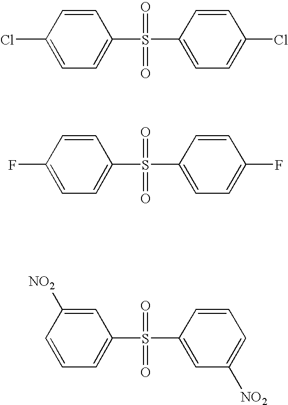

These compounds may be used singly or in a combination of 2 or more types.

Specific examples of the compound represented by the formula (27) include hydroquinone, resorcin, 2-methylhydroquinone, 2-ethylhydroquinone, 2-propylhydroquinone, 2-butylhydroquinone, 2-hexylhydroquinone, 2-octylhydroquinone, 2-decanylhydroquinone, 2,3-dimethylhydroquinone, 2,3-diethylhydroquinone, 2,5-dimethylhydroquinone, 2,5-diethylhydroquinone, 2,6-dimethylhydroquinone, 2,3,5-trimethylhydroquinone, 2,3,5,6-tetramethylhydroquinone, 4,4′-dihydroxybiphenyl, 2,2′-dihydroxybiphenyl, 3,3′-dimethyl-4,41-dihydroxybiphenyl, 3,3′,5,5′-tetramethyl-4,4′-dihydroxybiphenyl, 3,3′-dichloro-4,4′-dihydroxybiphenyl, 3,3′,5,5′-tetrachloro-4,4′-dihydroxybiphenyl, 3,3′-dibromo-4,4′-dihydroxybiphenyl, 3,3′,5,5′-tetrabromo-4,4′-dihydroxybiphenyl, 3,3′-difluoro-4,4′-dihydroxybiphenyl, 3,3′,5,5′-tetrafluoro-4,4′-dihydroxybiphenyl, 4,4′-dihydroxydiphenylmethane, 2,2′-dihydroxydiphenylmethane, 3,3′-dimethyl-4,4′-dihydroxydiphenylmethane, 3,3′,5,5′-tetramethyl-4,4′-dihydroxydiphenylmethane, 3,3′-dichloro-4,4′-dihydroxydiphenylmethane, 3,3′,5,5′-tetrachloro-4,4′-dihydroxydiphenylmethane, 3,3′-dibromo-4,4′-dihydroxydiphenylmethane, 3,3′,5,5′-tetrabromo-4,4′-dihydroxydiphenylmethane, 3,3′-difluoro-4,4′-dihydroxydiphenylmethane, 3,3′,5,5′-tetrafluoro-4,4′-dihydroxydiphenylmethane, 4,4′-dihydroxydiphenyl ether, 2,2′-dihydroxydiphenyl ether, 3,3′-dimethyl-4,4′-dihydroxydiphenyl ether, 3,3′,5,5′-tetramethyl-4,4′-dihydroxydiphenyl ether, 3,3′-dichloro-4,4′-dihydroxydiphenyl ether, 3,3′,5,5′-tetrachloro-4,4′-dihydroxydiphenyl ether, 3,3′-dibromo-4,4′-dihydroxydiphenyl ether, 3,3′,5,5′-tetrabromo-4,4′-dihydroxydiphenyl ether, 3,3′-difluoro-4,4′-dihydroxydiphenyl ether, 3,3′,5,5′-tetrafluoro-4,4′-dihydroxydiphenyl ether, 4,4′-dihydroxydiphenyl sulfide, 2,2′-dihydroxydiphenyl sulfide, 3,3′-dimethyl-4,4′-dihydroxydiphenyl sulfide, 3,3′,5,5′-tetramethyl-4,4′-dihydroxydiphenyl sulfide, 3,3′-dichloro-4,4′-dihydroxydiphenyl sulfide, 3,3′,5,5′-tetrachloro-4,4′-dihydroxydiphenyl sulfide, 3,3′-dibromo-4,4′-dihydroxydiphenyl sulfide, 3,3′,5,5′-tetrabromo-4,4′-dihydroxydiphenyl sulfide, 3,3′-difluoro-4,4′-dihydroxydiphenyl sulfide, 3,3′,5,5′-tetrafluoro-4,4′-dihydroxydiphenyl sulfide, 4,4′-dihydroxydiphenyl sulfone, 2,2′-dihydroxydiphenyl sulfone, 3,3′-dimethyl-4,4′-dihydroxydiphenyl sulfone, 3,3′,5,5′-tetramethyl-4,4′-dihydroxydiphenyl sulfone, 3,3′-dichloro-4,4′-dihydroxydiphenyl sulfone, 3,3′,5,5′-tetrachloro-4,4′-dihydroxydiphenyl sulfone, 3,3′-dibromo-4,4′-dihydroxydiphenyl sulfone, 3,3′,5,5′-tetrabromo-4,4′-dihydroxydiphenyl sulfone, 3,3′-difluoro-4,4′-dihydroxydiphenyl sulfone, 3,3′,5,5′-tetrafluoro-4,4′-dihydroxydiphenyl sulfone, 2,2-bis(4-hydroxyphenyl)propane, 2,2-bis(2-hydroxyphenyl)propane, 2,2-bis(3-methyl-4-hydroxyphenyl)propane, 2,2-bis(3-chloro-4-hydroxyphenyl)propane, 2,2-bis(3,5-dichloro-4-hydroxyphenyl)propane, 2,2-bis(3-bromo-4-hydroxyphenyl)propane, 2,2-bis(3,5-dibromo-4-hydroxyphenyl)propane, 2,2-bis(3-fluoro-4-hydroxyphenyl)propane, 2,2-bis(3,5-difluoro-4-hydroxyphenyl)propane, 2,2-bis(3,5-dimethyl-4-hydroxyphenyl)propane, α,α′-bis(4-hydroxyphenyl)-1,4-diisopropylbenzene, α,α′-bis(2-hydroxyphenyl)-1,4-diisopropylbenzene, α,α′-bis(4-hydroxyphenyl)-1,3-diisopropylbenzene, α,α′-bis(2-hydroxyphenyl)-1,3-diisopropylbenzene, α,α′-bis(3-methyl-4-hydroxyphenyl)-1,4-diisopropylbenzene, α,α′-bis(3,5-dimethyl-4-hydroxyphenyl)-1,4-diisopropyl-benzene, α,α′-bis(3-methyl-4-hydroxyphenyl)-1,3-diisopropylbenzene and α,α′-bis(3,5-dimethyl-4-hydroxyphenyl)-1,3-diiso-propylbenzene. These aromatic diols may be used singly or in a mixture of 2 or more types.

The blending ratio of a compound represented by the formula (26) to a compound represented by the formula (27) is preferably 0.7-1.3 moles, more preferably 0.9-1.1 moles, and further preferably 0.95-1.05 moles of a compound represented by the formula (26) relative to 1 mole of a compound represented by the formula (27).

When polycondensing a compound represented by the formula (26) and a compound represented by the formula (27) to synthesize the proton acid group-containing polysulfone (solid electrolyte) of the invention, a method in which they are polycondensed in the presence of a basic compound is used preferably.

There is no particular restriction on the type of the basic compound, reaction condition and the like, and a publicly known basic compound, reaction condition and the like may be applied. Examples of the basic compound include compounds of basic metals such as alkali metals and alkali earth metals, carbonate, acetate, hydroxide, quaternary ammonium salt and phosphonium salt of various metals, and organic bases.

The use amount of these basic compounds is preferably 0.05-10.0 moles, more preferably 0.1-4.0 moles, and further preferably 0.5-2.5 moles relative to 1 mole of the aromatic diol represented by the formula (27).

The reaction for producing the polymer compound for use in the solid electrolyte of the invention is preferably carried out in a solvent. Preferable examples include such solvents as those described below:

### 1) Ether-Based Solvent

1,2,-dimethoxyethane, bis(2-methoxyethyl)ether, 1,2-bis(2-methoxyethoxy)ethane, tetrahydrofuran, bis[2-(2-methoxyethoxy)ethyl]ether, 1,4-dioxane, and the like;

### 2) Aprotic Amide-Based Solvent

N,N-dimethylformamide, N,N-dimethylacetamide, N,N-diethylacetamide, N-methyl-2-pyrrolidone, 1,3-dimethyl-2-imidazolidinone, N-methylcaprolactam, hexamethylphosphorotriamide and the like;

### 3) Amine-Based Solvent

pyridine, quinoline, isoquinoline, α-picoline, β-picoline, γ-picoline, isophorone, piperidine, 2,4-lutidine, 2,6-lutidine, trimethylamine, triethylamine, tripropylamine, tributylamine and the like; and

### 4) Other Solvents

dimethyl sulfoxide, dimethyl sulfone, diphenyl ether, sulfolane, diphenylsulfone, tetramethylurea, anisole and the like.

These solvents may be used singly, or in a mixture of 2 or more types. Further, a solvent represented in item 5) below may also be mixed and used. When the solvent is used in a mixture, it is not necessarily required to select such combination that they are dissolved with each other at an arbitrary ratio. They may be not mixed with each other to become uneven.

The concentration of the reaction (hereinafter, referred to as polymerization concentration) carried out in the solvent is not restricted in any circumstances.

A compound represented by the formula (27) and a compound represented by the formula (26) are reacted in the above-described solvent to give a polysulfone containing a proton acid group. More preferable solvents for the reaction are aprotic amide-based solvents in the item 2) and dimethyl sulfoxide in the item 4) described above.

The atmosphere of the reaction is not particularly determined, but an atmosphere of air, nitrogen, helium, neon, argon or the like is preferable, that of an inert gas is more preferable, and that of nitrogen or argon is further preferable.

In addition, in order to remove water generating through the reaction from the reaction system, other solvent may coexist. Examples of the solvent can be used include those described in item 5) below.

5) Benzene, toluene, o-xylene, m-xylene, p-xylene, chlorobenzene, o-dichlorobenzene, m-dichlorobenzene, p-dichlorobenzene, bromobenzene, o-dibromobenzene, m-dibromobenzene, p-dibromobenzene, o-chlorotoluene, m-chlorotoluene, p-chlorotoluene, o-bromotoluene, m-bromotoluene, p-bromotoluene and the like. These solvents may be used singly or in a mixture of 2 or more types.

There is no particular restriction on reaction temperature, reaction time and reaction pressure, and publicly known conditions can be applied. That is, the reaction temperature is preferably 50-300° C., more preferably 100-270° C., and further preferably 130-250° C. The reaction time may be suitably determined according to the type of monomer, the type of solvent, the reaction temperature and the like to be employed, and is preferably 1-72 hours, more preferably 3-48 hours, and further preferably 5-24 hours. As to the reaction pressure, any of increased, reduced and ordinary pressures may be acceptable.

In the invention, in order to introduce a sulfonic acid group to a polymer compound to which a sulfonic acid group is not introduced yet, a following introduction method may be used. In addition to direct introduction of a sulfonic acid group to the polymer compound, a sulfonic acid group may be first introduced to a monomer, which is then polymerized.

For example, there is such method that, when n1 is 1 and m2 thereof is 0 in the formula (1), it is converted to halogenomethylated polysulfone using a hologenomethylating agent such as chloromethylmethyl ether described later, which is then reacted with a compound containing a thioether bond in an alkyl chain and a halogen (for example, sodium 3-mercapto-1-difluoro-1-propane sulfonate and sodium 3-mercapto-1,2-difluoro-1-sulfonate mentioned below), and, after that, is subjected to salt exchange to introduce a sulfonic acid group.

In addition, there is such method that, when n1 is 1 and B¹ is a halogen-substituted alkylene group in the formula (1) ,

it is converted to halogenomethylated polysulfone using a hologenomethylating agent such as chloromethylmethyl ether described later, which is then reacted with a compound in which halogen bonds to the end of an alkyl chain and said alkyl chain is halogenated (for example, tetrafluoro-2-(tetrafluoro-2-indoetoxy)ethanesulfonylfluoride mentioned below), and, after that, is subjected to hydrolysis to introduce a sulfonic acid group.

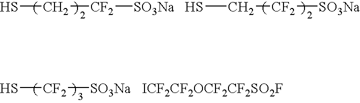

In the invention, examples of the halogenoalkyl group include halogenoalkyl groups (having 1-6 carbon atoms) such as a chloromethyl group, a bromomethyl group, an iodomethyl group, a chloroethyl group, a bromoethyl group, an iodoethyl group, a chloropropyl group, a bromopropyl group, an iodopropyl group, a chlorobutyl group, a bromobutyl group, an iodobutyl group, a chloropentyl group, a bromopentyl group, an iodopentyl group, a chlorohexyl group, a bromohexyl group and an iodohexyl group. Among them, a halogenomethyl group is preferable.

In order to introduce a halogenomethyl group that is preferable in the invention to an aromatic ring (halogenomethylating reaction of an aromatic ring), publicly known reactions can be used broadly. For example, a chloromethyl group is introduced to an aromatic ring by carrying out a chloromethylating reaction by using chloromethylmethyl ether, 1,4-bis(chloromethoxy)butane, 1-chloromethoxy-4-chlorobutane or the like as a chloromethylating agent, and a Lewis acid such as tin chloride, zinc chloride, aluminum chloride and titanium chloride or hydrofluoric acid as a catalyst. The reaction is preferably carried out in a homogeneous system using such solvent as dichloroethane, trichloroethane, tetrachloroethane, chlorobenzene, dichlorobenzene or nitrobenzene. Further, paraformaldehyde and hydrogen chloride or hydrogen bromide may be used to carry out a halogenomethylation reaction.

The amount of the sulfonic acid group in the aforementioned polymer compound obtained according to the aforementioned way is preferably 0.05-2, more preferably 0.3-1.5 relative to one unit of the unit (B) constituting the polymer. The sulfonic acid group of 0.05 or more makes the proton conductivity of the solid electrolyte higher, and, on the other hand, the group of 2 or less can more effectively inhibit the polymer compound from becoming water-soluble polymer due to a too enhanced hydrophilicity, or from decreasing in durability even if it is not lead to be water-soluble.

The molecular weight of polymer precursor thus obtained, which will become the polymer compound of the invention after sulfonation, is preferably 1,000-1,000,000, more preferably 1,500-200,000 in weight-average molecular weight in terms of polystyrene. The molecular weight of 1,000 or more can more effectively inhibit insufficiency in film properties such as generation of a crack in a molded film, and can more effectively enhance strength properties. On the other hand, that of 1,000,000 or less can more effectively inhibit such problems that solubility becomes insufficient or the solution viscosity is high to result in poor processability.

In this connection, the structure of the polymer compound used in the invention can be checked by infrared spectrum of S═O absorption at 1,030-1,045 cm⁻¹ and 1,160-1,190 m⁻¹, C—O—C absorption at 1,130-1,250 cm⁻¹, C═O absorption at 1,640-1,660 cm⁻¹ and the like. The composition ratio of these can be known by neutralization titration of the sulfonic acid or elemental analysis. Further, the construction can be checked from the peak of an aromatic proton at 6.8-8.0 ppm by a nuclear magnetic resonance spectrum (¹H-NMR).

The solid electrolyte of the invention contains the above-described polymer compound, and may contain, in addition, an inorganic acid such as sulfuric acid, phosphoric acid and heteropoly acid, an organic acid such as carboxylic acid, or a suitable amount of water, in combination.

In a film-forming process, film-forming may be carried out by extrusion molding, casting or coating of a liquid prepared by holding the polymer compound as a raw material at a temperature higher than the melting point thereof, or by dissolving the compound using a solvent. These operations can be practiced by using a film-forming machine provided with rolls such as calendar rolls or cast rolls, or a T die, or by press molding using a press machine. Stretching process may be added to control film thickness or improve film properties.

Further, the film may be subjected to surface treatment after the film-forming process. Such surface treatments can be mentioned as surface roughening, surface cutting, removing and coating. Sometimes these treatments can improve adherence of the film with an electrode.

The solid electrolyte to be obtained preferably is in the form of a film, whose thickness is preferably 10-500 μm, more preferably 25-150 μm. It may be molded to be a film shape, or molded in a balk body and then cut and processed into a film shape.

The solid electrolyte of the invention may be impregnated in fine pores of a porous substrate to form a film. A film may be formed by coating and impregnating a reaction solution having been subjected to the second process to a porous substrate, or by dipping the substrate in the reaction solution to fill fine pores with the solid electrolyte. Preferable examples of the substrate having fine pores include porous polypropylene, porous polytetrafluoroethylene, porous cross-linked heat resistant polyethylene and porous polyimide.

### Other Ingredients of the Solid Electrolyte

To the solid electrolyte of the invention, according to need, an oxidation inhibitor, a fiber, a fine particle, a water-absorbing agent, a plasticizer, a compatibilizing agent or the like may be added in order to enhance film properties. The content of these additives is preferably in a range of 1-30% by mass relative to the total amount of the solid electrolyte.

Preferable examples of the oxidation inhibitor include (hindered)phenol-based, mono- or di-valent sulfur-based, tri- or penta-phosphorous-based, benzophenone-based, benzotriazole-based, hindered amine-based, cyanoacrylate-based, salicylate-based, and oxalic acid anilide-based compounds. Specifically, compounds described in JP-A-8-53614, JP-A-10-101873, JP-A-11-114430 and JP-A-2003-151346 can be mentioned.

Preferable examples of the fiber include perfluorocarbon fiber, cellulose fiber, glass fiber, polyethylene fiber and the like. Specifically, fibers described in JP-A-10-312815, JP-A-2000-231928, JP-A-2001-307545, JP-A-2003-317748, JP-A-2004-63430 and JP-A-2004-107461 can be mentioned.

Preferable examples of the fine particle include fine particles composed of silica, alumina, titanium oxide, zirconium oxide and the like. Specifically, those described in JP-A-6-111834, JP-A-2003-178777, and JP-A-2004-217921 can be mentioned.

Preferable examples of the water-absorbing agent (hydrophilic material) include cross-linked polyacrylates, starch-acrylates, poval, polyacrylonitrile, carboxymethyl cellulose, polyvinylpyrrolidone, polyglycol dialkylether, polyglycol dialkylester, silica gel, synthesized zeolite, alumina gel, titania gel, zirconia gel, and yttria gel. Specifically, water-absorbing agents described in JP-A-7-135003, JP-A-8-20716 and JP-A-9-251857 can be mentioned.

Preferable examples of the plasticizer include phosphoric acid ester-based compounds, phthalic acid ester-based compounds, aliphatic monobasic acid ester-based compounds, aliphatic dibasic acid ester-based compounds, dihydric alcohol ester-based compounds, oxyacid ester-based compounds, chlorinated paraffins, alkylnaphthalene-based compounds, sulfone alkylamide-based compounds, oligo ethers, carbonates, and aromatic nitrites. Specifically, those described in JP-A-2003-197030, JP-A-2003-288916, and JP-A-2003-317539 can be mentioned.

Further, the solid electrolyte of the invention may be incorporated with various polymer compounds for the purpose of (1) enhancing mechanical strength of the film, or (2) enhancing acid concentration in the film.

(1) For the purpose of enhancing mechanical strength, such polymer compound is suitable that has molecular weight of around 10,000-1,000,000 and good compatibility with the solid electrolyte of the invention. For example, perfluorinated polymer, polystyrene, polyethylene glycol, polyoxetane, poly(meth)acrylate, polyether ketone, polyether sulfone, and polymers of 2 or more of these are preferable, and preferable content is in a range of 1-30% by mass relative to the whole.

When the solid electrolyte of the invention is used for a fuel cell, a solid electrolyte composite film that is obtained by combining the solid electrolyte with a support may be used. Here, the support constitutes a base material into which the solid electrolyte of the invention is impregnated, and is used mainly for further enhancing strength, flexibility and durability of the solid electrolyte of the invention. Accordingly, a material that satisfies the above-described intended purpose may be used independently of the shape, such as a fibril shape or porous film shaper and material. However, use of a porous film is very effective when taking convenient use as a barrier film of a solid polymer electrolyte fuel cell into consideration.

A porous film used for the purpose has a thickness of ordinarily 1-300 μm, preferably 3-150 μm, and more preferably 5-100 μm; a pore diameter of ordinarily 0.01-10 μm, and preferably 0.02-7 μm; and a porosity of ordinarily 20-98%, and preferably 30-95%. The thickness of a porous support film of 1 μm or more results in a more effective strength addition or reinforcement such as giving flexibility and durability after it is made into a composite, whereby gas leakage (cross leak) hardly occurs. On the other hand, the film thickness of 100 μm or less results in a not too high electric resistance, whereby the obtained composite film becomes more preferable as a barrier film of a solid polymer fuel cell. The pore diameter of 0.02 μm or more allows the solid electrolyte to impregnate easily into the pore, and that of 7 μm or less tends to strengthen the reinforcement effect on the solid electrolyte. The porosity of 20% or more makes resistance as a solid electrolyte film not too large, and that of 98% or less tend to inhibit decrease in the reinforcement effect caused by lowering of strength of the porous film itself. The material for the porous support film is preferably an aliphatic polymer or a fluorine-containing polymer from the view point of heat resistance and reinforcement effect on physical strength.

Examples of the aliphatic polymer that can be used suitably include polyethylene, polypropylene, ethylene-propylene copolymer and the like, but are not restricted to these. As the fluorine-containing polymer, publicly known thermoplastic resins having at least one carbon-fluorine bond in the molecule may be used. Ordinarily, those having such structure that all or most of the hydrogen atoms of an aliphatic polymer have been substituted with fluorine atoms are preferably used.

Examples of fluorine-containing polymer that can be preferably used include polytrifluoroethylene, polytetrafluoroethylene, polychlorotrifluoroethylene, poly(tetrafluoroethylene-hexafluoropropylene), poly(tetrafluoroethylene-perfluoroalkyl ether), polyvinylidene fluoride and the like, but are not restricted to these. Among these, in the invention, polytetrafluoroethylene and poly(tetrafluoroethylene-hexafluoropropylene) are preferable, and polytetrafluoroethylene is particularly preferable. These fluorine-containing resins preferably have an average molecular weight of 100,000 or more from the point of good mechanical strength.

When using the solid electrolyte of the invention or a composite film including the solid electrolyte, for a fuel cell, there is no particular restriction on the film thickness, but it is preferably 1-300 μm, more preferably 3-150 μm, and further preferably 5-100 μm. A too small film thickness tends to lower the film strength, and a too large film thickness heighten electric resistance, which is undesirable as a barrier film of a solid polymer fuel cell. The film thickness can be controlled by suitably selecting concentration of a polymer electrolyte solution or coating volume of the polymer electrolyte solution, thickness of the porous support film and coating thickness onto the porous support film. Further, additives such as an oxidation inhibitor may be incorporated within a range that does not impair the purpose of the invention.

A compatibilizing agent has a boiling point or sublimation point of preferably 250° C. or more, and more preferably 300° C. or more.

(2) For the purpose of increasing acid concentration, such polymer compound is preferable that has a proton acid site such as perfluorocarbon sulfonic acid polymers as represented by Nafion®, poly(meth)acrylates having a phosphoric acid group in a side chain, or sulfonated heat resistant aromatic polymers such as sulfonated polyether ether ketone, sulfonated polyether sulfone, sulfonated polysulfone or sulfonated polybenzimidazole, which is preferably contained in a range of 1-30% by mass relative to the whole.

As the solid electrolyte of the invention, those having following performances are preferable.

The proton conductivity is preferably 0.1 S/cm or more, and more preferably 0.2 S/cm, for example, in water at 80° C.

As to strength, the storage elastic modulus according to DMA (viscoelastic analysis) is preferably 0.5 GPa or more, more preferably 1.0 GPa or more, and particularly preferably 1.5 GPa or more.

As to durability, rate of change of weight and ion-exchange capacity before and after treatment in 30% hydrogen peroxide at a constant temperature is preferably 20% or less, more preferably 10% or less. Further, a volume swelling ratio in an ion-exchanged water at a constant temperature is preferably 10% or less, more preferably 5% or less. Tg (glass transition temperature) is preferably 120° C. or more, more preferably 150° C. or more, and particularly preferably 170° C. or more.

The solid electrolyte of the invention preferably has a stable water absorption coefficient and moisture content. Further, it preferably has a substantially negligible solubility to alcohols, water and mixed solvents of these. In addition, it preferably has a substantially negligible weight loss and figure change when dipped in the above-described solvent.

When it is formed in a film shape, it preferably has a higher ion conductivity in the direction from front face to rear face compared with those in other directions.

When the solid electrolyte of the invention is formed in a film shape, thickness thereof is preferably 1-300 μm. Heat-resistant temperature of the solid electrolyte of the invention is preferably 100° C. or more, more preferably 150° C. or more, and further preferably 200° C. or more. The heat-resistant temperature can be defined, for example, as a time period when weight loss reaches 5% by heating the film at a rate of 1° C./min. The weight loss is calculated while excluding evaporation quantity of water and the like.

Further, when the solid electrolyte of the invention is used for a fuel cell, an active metal catalyst that facilitates the oxidation-reduction reaction of an anode fuel and a cathode fuel may be added. As the result, fuels permeating into the solid electrolyte are consumed in the solid electrolyte without reaching the other electrode, whereby crossover can be prevented. An active metal type to be used can not be restricted as long as it functions as an electrode catalyst, but platinum or an alloy based on platinum is suitable.

### Fuel Cell

The solid electrolyte of the invention can be used for a Membrane and Electrode Assembly (hereinafter, referred to as “MEA”) and a fuel cell employing the MEA.

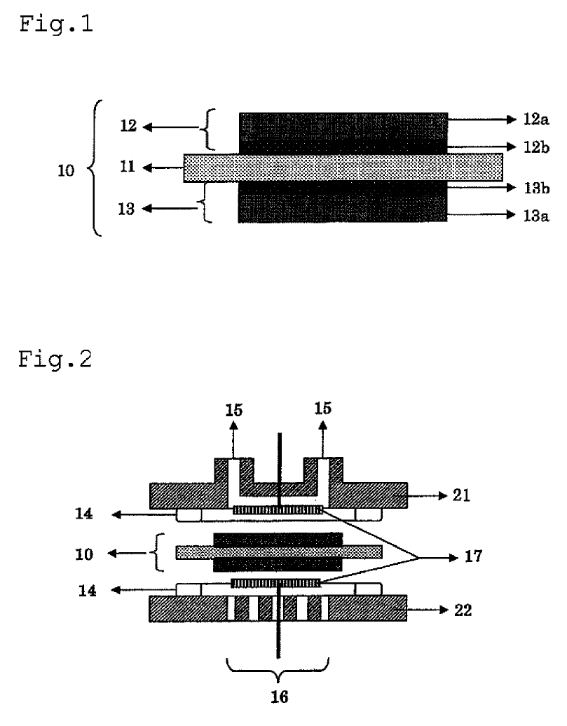

FIG. 1 shows an example of schematic cross-sectional view of the MEA of the invention. The MEA 10 includes a film-shaped solid electrolyte 11, and an anode electrode 12 and a cathode electrode 13 facing to each other while holding the solid electrolyte 11 therebetween.

The anode electrode 12 and the cathode electrode 13 are composed of porous conductive sheets (for example, carbon paper, conductive layer) 12a, 13a, and catalyst layers 12b, 13b. The catalyst layers 12b, 13b are composed of a dispersed substance prepared by dispersing a carbon particle (such as Ketchen black, acetylene black and carbon nano tube) carrying a catalyst metal such as platinum powder in a proton conductive material (for example, Nafion® or the like). In order to bring the catalyst layers 12b, 13b into close contact with the solid electrolyte 11, such method is generally used that the porous conductive sheets 12a, 13a coated with catalyst layers 12b, 13b are pressure-bonded to the solid electrolyte 11 by a hot press method (preferably 120-130° C., 2-100 kg/cm²), or the catalyst layers 12b, 13b coated on a suitable support are transferred and pressure-bonded to the solid electrolyte 11, which is then sandwiched between the porous conductive sheets 12a, 13a.

FIG. 2 shows an example of a fuel cell structure. The fuel cell includes the MEA 10 and a pair of separators 21, 22 holding the MEA 10 therebetween, current collectors 17 constituted of a stainless net and attached to the separators 21, 22, and packings 14. To the anode side separator 21, an anode side opening 15 is arranged, and to the cathode side separator 22, a cathode side opening 16 is arranged. From the anode side opening 15, a gas fuel such as hydrogen or alcohols (methanol etc.) or a liquid fuel such as an aqueous alcohol solution is supplied, and from the cathode side opening 16, an oxidant gas such as oxygen gas or air is supplied.

For the anode electrode and cathode electrode, a catalyst composed of carbon material carrying an active metal particle such as platinum is used. The particle size of the commonly used active metal falls within 2-10 nm. A smaller particle size is advantageous because it leads to a larger surface area per unit mass to result in a enhanced activity, however, a too small size makes it difficult to disperse the particle without aggregation. Thus, the lower limit is said to be around 2 nm.

Activated polarization in a hydrogen-oxygen system fuel cell is greater for a cathodic pole (air pole) compared with an anodic pole (hydrogen pole). This is because reaction at the cathodic pole (reduction of oxygen) is slower compared with that at the anodic pole. In order to enhance activity of the oxygen pole, various platinum-based bimetals such as Pt—Cr, Pt—Ni, Pt—Co, Pt—Cu, Pt—Fe can be used. In a fuel cell which employs a reformed gas from fossil fuels containing carbon monoxide as anode fuel, suppression of catalyst poisoning by CO is important. For this purpose, platinum-based bimetals such as Pt—Ru, Pt—Fe, Pt—Ni, Pt—Co and Pt—Mo, and trimetals such as Pt—Ru—Mo, Pt—Ru—W, Pt—Ru—Co, Pt—Ru—Fe, Pt—Ru—Ni, Pt—Ru—Cu, Pt—Ru— Sn and Pt—Ru—Au can be used.

As to a carbon material for supporting an active metal, acetylene black, Vulcan XC-72, Ketchen black, carbon nanohorn (CNH) and carbon nanotube (CNT) are preferably used.

The functions of the catalyst layer are: (1) to transport the fuel to the active metal, (2) to provide a field for oxidation reaction (anodic pole) and reduction reaction (cathodic pole) of the fuel, (3) to transmit electrons generated by oxidation-reduction to the current collector, and (4) to transport protons generated by the reaction to the solid electrolyte. In order to accomplish (1), the catalyst layer must be porous to allow the liquid and gas fuels to permeate deeply. (2) is borne by the aforementioned active metal catalyst, and (3) is borne by the also aforementioned carbon material. In order to fulfill the function of (4), the catalyst layer is mixed with a proton conductive material.

As to the proton conductive material of the catalyst layer, that is, a binder, a solid having a proton-donating group can be used without any restriction, but there can be mentioned a film of polymer compounds having an acid residue used for the solid electrolyte, perfluorocarbon sulfonic acid polymers as represented by Nafion®, poly(meth)acrylates having a phosphorous group in a side-chain, heat-resistant aromatic polymers such as sulfonated polyetherether ketone, sulfonated polyether ketone, sulfonated polyether sulfone, sulfonated polysulfone and sulfonated polybenzimidazole, sulfonated polystyrene, sulfonated polyoxetane, sulfonated polyimide, sulfonated polyphenylene sulfide, sulfonated polyphenylene oxide and sulfonated polyphenylene. Specifically, there can be mentioned those described in JP-A-2002-110174, JP-A-2002-105200, JP-A-2004-10677, JP-A-2003-132908, JP-A-2004-179154, JP-A-2004-175997, JP-A-2004-247182, JP-A-2003-147074, JP-A-2004-234931, JP-A-2002-289222 and JP-A-2003-208816. Use of the solid electrolyte of the invention for a catalyst layer is more advantageous because it becomes the same kind of material as the solid electrolyte to enhance electrochemical adhesion between the solid electrolyte and the catalyst layer.

In addition, when sulfonated polysulfone is used as the binder, a dispersion liquid containing an ionic polymer particle having a volume average particle size of 1-200 nm is favorably used. One example of the preparation method of a dispersion liquid of an ionic polymer particle is described.

An ionic polymer particle is produced by continuously mixing a poor solvent and an ionic polymer solution, wherein the poor solvent hardly dissolves an ionic polymer, and the ionic polymer solution has compatibility with the poor solvent and is prepared by dissolving the ionic polymer in a good solvent which can easily dissolve the ionic polymer. Here, “continuous mixing” means that the poor solvent and the ionic polymer solution are mixed in the fluid state, and therefore new mixture thereof is being produced as time goes on.

Here, the poor solvent which hardly dissolves an ionic polymer is, for example, the solvent having a solubility of at most 10 mg/ml.

The poor solvent may use one kind or more. Preferable example of a poor solvent used in the present invention is water.

The good solvent is not particularly limited as long as it dissolves the ionic polymer, and blends with the poor solvent. It may be a mixture of at least two kinds of good solvents.

The good solvent is preferably an organic solvent to be easily removable from a dispersion liquid of ionic polymer particle. As such solvent, methanol, ethanol, isopropyl alcohol, 1-butanol, n-methylpyrrolidone, acetone, tetrahydrofuran, dimethylformamide, ethylene diamine, acetonitrile, methyl ethyl ketone, dimethyl sulfoxide, dichloromethane, dimethyl acetamide and the like are exemplified.

In order to obtain an ionic polymer particle having a diameter of 1 to 200 nm as a submicron order, when the poor solvent and the ionic polymer particle are blended, the volume flow ratio of the poor solvent to the good solvent (the former:the latter) is preferably in the range of 1:1 to 100:1, more preferable 5:1 to 100:1, and further more preferably 10:1 to 100:1. In order to obtain dispersion liquid of an ionic polymer particle which includes smaller size particles and is excellent in dispersion stability by means of the blending of the poor solvent and the ionic polymer particle solution, it is preferable that a dispersion stabilizer is contained in the poor solvent or the ionic polymer particle solution.

Further, a material as the binder of the catalyst layer is required to have such performance that allows the fuel to permeate deeply, and has an oxygen permeability (mol/cm·s) of preferably 5×10⁻¹² or more, more preferably 8×10⁻¹², and particularly preferably 1.2×10⁻¹¹ at 75° C.

The catalyst layer preferably contains an water repellant additionally. As to the water repellant, fluorine-containing resins having water-repellent property is preferable, and those excellent in heat resistance and oxidation resistance is more preferable. For example, polytetrafluoroethylene, tetrafluoroethylene-perfluoroalkylvinyl ether copolymer and tetrafluoroethylene-hexafluoropropylene copolymer can be mentioned.

Suitable use amount of the active metal falls within 0.03-10 mg/cm² from the viewpoint of battery output power and economical efficiency. Suitable amount of the carbon material that carries the active metal is 1-10 times the mass of the active metal. Suitable amount of the proton conductive material is 0.1-0.7 time the mass of the active metal-carrying carbon.

The conductive layer is also called an electrode base material, a permeable layer or a liner substance, and bears roles of function of current collection and prevention of degradation of gas permeation caused by accumulation of water. Usually, carbon paper or carbon cloth is used, and one having been subjected to polytetrafluoroethylene (PTFE) treatment for the purpose of water repellent finish can also be used.

A carbon material is preferably used as a carrier of a catalyst metal (electrode catalyst) such as a platinum particle. Methods for allowing the carrier to carry the catalyst metal include a heat reduction method, a sputtering method, a pulse laser deposition method, a vacuum evaporation method and the like (for example, WO 2002/054514 etc.).

The current collector (bipolar plate) preferable has a combined function as a flow pass-forming member, which is made of graphite or metal provided with a gas flow pass on the surface or the like. The MEA may be inserted between such current collectors, a plurality of which are piled up to manufacture a fuel cell stack.

A method for manufacturing the electrode will be described. A fluorine-containing resin-based proton conductive material as represented by Nafion® or the solid electrolyte of the invention is dissolved in a solvent, which is mixed and dispersed with a carbon material carrying a catalyst metal to prepare a dispersion liquid. Preferable examples of the solvent of the dispersion liquid include heterocyclic compounds (such as 3-methyl-2-oxazolidinone and N-methylpyrrolidone), cyclic ethers (such as dioxane and tetrahydrofuran), chain ethers (such as diethyl ether, ethylene glycol dialkyl ether, propylene glycol dialkyl ether, polyethylene glycol dialkyl ether and polypropylene glycol dialkyl ether), alcohols (such as methanol, ethanol, isopropanol, ethylene glycol monoalkyl ether, propylene glycol monoalkyl ether, polyethylene glycol monoalkyl ether and polypropylene glycol monoalkyl ether), polyhydric alcohols (ethylene glycol, propylene glycol, polyethylene glycol, polypropylene glycol and glycerin), nitryl compounds (such as acetonitryl, glutarodinitrile, methoxyacetonitryl, propyonitryl and benzonitryl), nonpolar solvents (such as toluene and xylene), chlorine-containing solvents (such as methylene chloride and ethylene chloride), amides (such as N,N-dimethylformamide, N,N-dimethylacetamide and acetamide) and water. Among these, heterocyclic compounds, alcohols, polyhydric alcohols and amides are preferably used.

The dispersion may be carried out by stirring, and ultrasonic dispersion, a ball mill and the like may also be used. The resulting dispersion liquid may be coated by using a coating method such as a curtain coating, extrusion coating, roll coating, spin coating, dip coating, bar coating, spray coating, slide coating and print coating methods.

Coating of the dispersion liquid will be described. In a coating process, a film may be formed by extrusion molding, or casting or coating of the above-described dispersion liquid. A support in this case is not particularly restricted, and preferable examples thereof include a glass substrate, a metal substrate, a polymer film, a reflection board and the like. Examples of the polymer film include a film of cellulose-based polymers such as triacetyl cellulose (TAC), ester-based polymers such as polyethylene terephthalate (PET) and polyethylene naphthalate (PEN), fluorine-containing polymers such as polytrifluoroethylene (PTFE), and polyimide. The coating may be carried out according to a known system such as a curtain coating, extrusion coating, roll coating, spin coating, dip coating, bar coating, spray coating, slide coating and print coating methods. In particular, use of a conductive porous material (carbon paper, carbon cloth) as the support makes direct manufacture of the catalyst electrode possible.

These operations may be carried out by a film-forming machine that uses rolls such as calendar rolls or cast rolls, or a T die, or press molding by a press machine may also be utilized. Further, a stretching process may be added to control the film thickness or improve film characteristics. As another method, a method, in which an electrode catalyst having been formed in a paste shape as described above is directly sprayed to the solid electrolyte film with an ordinary sprayer to form the catalyst layer, can be also used. Control of the spray time and the spray volume makes formation of a uniform electrode catalyst layer possible.

Drying temperature in the coating process relates to the drying speed, and can be selected in accordance with properties of the material. It is preferably −20° C.-150° C., more preferable 20° C.-120° C., and further preferably 50° C.-100° C. A shorter drying time is preferable from the viewpoint of productivity, however, a too short time tends to easily generate such defects as bubbles or surface irregularity. Therefore, drying time of 1 minute-48 hours is preferable, 5 minutes-10 hours is more preferable, and 10 minutes-5 hours is further preferable. Control of humidity is also important, and relative humidity (RH) is preferably 25-100%, and more preferably 50-95%.

The coating liquid (dispersion liquid) in the coating process preferably contains a small amount of metal ions, and in particular, it contains a small amount of transition metal ions, especially an iron, nickel and cobalt ions. The content of transition metal ions is preferably 500 ppm or less, and more preferably 100 ppm or less. Therefore, solvents used in the aforementioned processes preferably contains these ions in a small amount, too.

Further, a surface treatment may be carried out after performing the coating process. As to the surface treatment, surface roughening, surface cutting, surface removing or surface coating may be performed, which may, in some cases, improve adherence with the solid electrolyte film or the porous conductive material.

Thickness of the catalyst layer included in the MEA of the invention is preferably 5-200 μm, and particularly preferably 10-100 μm.

For manufacturing the MEA, following 4 methods are preferable.

(1) Proton conductive material coating method: wherein a catalyst paste (ink) containing an active metal-carrying carbon, a proton conductive substance and a solvent as fundamental components is directly coated on both sides of the solid electrolyte, to which porous conductive sheets are thermal compression-bonded (hot pressed) to manufacture an MEA of 5-layer structure.

(2) Porous conductive sheet coating method: wherein the catalyst paste is coated on the surface of the porous conductive sheet to form a catalyst layer, followed by thermal compression-bonding (hot pressing) with the solid electrolyte to manufacture an MEA of 5-layer structure. This method is the same as the above-described (1) except that the type of support to be coated is not identical.

(3) Decal method: wherein the catalyst paste is coated on a support (such as a polytetrafluoroethylene (PTFE) sheet) to form a catalyst layer, followed by thermal compression-bonding (hot pressing) to transfer the catalyst layer alone to the solid electrolyte to form a 3-layer MEA, to which a porous conductive sheet is pressure-bonded to manufacture an MEA of 5-layer structure.

(4) Later catalyst carrying method: wherein an ink, in which a carbon substance not carrying a platinum powder has been mixed with a proton conductive substance, is coated on a solid electrolyte, a porous conductive sheet or PTFE to form a film, followed by impregnating platinum ions into the solid electrolyte and reducing the ion to precipitate a platinum powder in the film, thereby forming a catalyst layer. After the formation of the catalyst layer, an MEA is manufactured by the aforementioned methods (1)-(3).

The above-described hot press is preferably carried out under following conditions.

The hot press temperature is ordinarily 100° C. or more, preferably 130° C. or more, and further preferably 150° C. or more, although it depends on the type of solid electrolyte.

The solid electrolyte may be of a proton type having a sulfonic acid as a substituent, or of a salt type having a salt of sulfonic acid as described in JP-A-2004-165096 and JP-A-2005-190702. The counter cation of a salt type sulfonic acid is preferably a mono- or di-valent cation, and more preferably a monovalent cation. Specifically, lithium ion, sodium ion, potassium ion or magnesium ion is preferable. Further, plural types may be employed from the group consisting of these cations and a proton.

When the above-described salt is used, in addition, the following process is necessary.

In order to use it for a fuel cell, the solid electrolyte must have proton conductivity. For the purpose, by contacting the solid electrolyte with an acid, a salt substitution percentage thereof is reduced to 99% or less of that before the contact. Contact with an acid after joining the electrode catalyst and the polymer electrolyte film can recover lowering in moisture content and ion conductivity of the film caused by thermal history that is given during the electrode joining.

The contact with an acid can be carried out using a publicly known method, including dipping in an acidic aqueous solution such as hydrochloric acid, or spraying of an acidic aqueous solution. Concentration of an acidic aqueous solution to be used may depend on degree of lowering in the ion conductivity, dipping temperature, dipping time and the like and, for example, an acidic aqueous solution of 0.0001-5 N may be used suitably. As to the dipping temperature, room temperature often can achieve sufficient conversion, and, in order to shorten the dipping time, the acidic aqueous solution may be heated. Although the dipping time depends on the concentration of the acidic aqueous solution and dipping temperature, a range of around 10 minutes-48 hours is preferable.

Such method may be also employed that a proton moving in the inside of the film functions as an acid upon operating a fuel cell to wash out a substituted cation, thereby allowing the film to exert a higher ion conductivity.

A higher operating temperature of a fuel cell is preferable, because catalyst activity enhances. But, ordinarily, it is operated at 50° C.-120° C., at which water content is easily controlled. Although a higher supply pressure of oxygen and hydrogen may be preferable because a fuel cell output increases, since probability of their contact through film breakage or the like also increases, the pressure is preferably controlled within a suitable range such as 1-3 atmospheric pressures.

Examples of material that can be used as the fuel for a fuel cell employing the solid electrolyte of the invention include, as anode fuel, hydrogen, alcohols (methanol, isopropanol, ethylene glycol etc.), ethers (dimethylether, dimethoxymethane, trimethoxymethane etc.), formic acid, boron hydride complexes, ascorbic acid and the like. As cathode fuel, oxygen (including oxygen in air), hydrogen peroxide and the like.

There are 2 ways to supply the aforementioned anode fuel and cathode fuel to respective catalyst layers, that is, (1) a method in which they are subjected to controlled circulation using an auxiliary machine such as a pump (active type), and (2) a method in which no auxiliary machine is used (passive type, in which, for example, liquid fuel is supplied by capillary action or free fall; and gas fuel is supplied by exposing a catalyst layer to air). Combination of these is also possible. The former has such advantage that a high output may be achieved by carrying out pressurized humidity conditioning of reaction gasses, but has such disadvantage that miniaturization is difficult. The latter has an advantage of possibility of miniaturization, but has a disadvantage of difficulty in generating a high output.

Generally, single cell voltage of a fuel cell is 1.2 V or less, therefore, single cells are used in series stacking in accordance with necessary voltage required from load. As to the stacking method, there are 2 usable methods, that is, “planar stacking” wherein single cells are aligned on a plane and “bipolar stacking” wherein single cells are stacked via a separator having fuel paths formed on both sides thereof. The former is suitable for a compact fuel cell, because the cathodic pole (air pole) is exposed on the surface, thereby making it easy to take in air and possible to form a thin type stacking. In addition to these, a method is proposed in which, while applying MEMS technology, microfabrication is given to a silicon wafer to form a stacking.

Various applications have been discussed about a fuel cell, including automobile use, household use and portable device use and the like. In particular, the hydrogen type fuel cell is expected as an energy source for various hot water-supplying and power generating apparatuses for home use, source of power for transport apparatuses, and an energy source for portable electronic devices, while utilizing the advantage of generating a high output. For example, the hot water-supplying and power generating apparatus to which it can be preferably applied includes home-use, collective housing-use and hospital-use apparatuses; the transport apparatus includes the automobile and marine vessel; and the portable device includes the cellular phone, mobile notebook computer and electronic still camera and the like. Examples of the suitably applicable portable device include a portable generator, outdoor lighting device and the like. In addition, it can preferably be used as a power source of a robot for industrial use or household use, or other toys and games. Furthermore, it is useful as a power source for charging a secondary battery mounted on these devices. In addition, an application as an emergency power source is also proposed.

### EXAMPLES

The present invention will be described more specifically below based on Examples. The material, use amount, percentage, treatment content, treatment procedure and the like represented in Examples below can be arbitrarily changed as long as the change results in no deviation from the intent of the invention. Accordingly, the scope of the invention is not restricted to the specific examples represented below.

### Example 1

### Manufacture of a Solid Electrolyte

While using 1 mol of bis(4-chlorophenylphenyl)sulfone based on 1 mol of 2,2-bis(4-hydroxyphenyl)propane as monomers, polysulfone (3-1) was synthesized according to a general polymerization method described in “Jikken Kagaku Kouza (Experimental Chemistry Course) ver. 4, vol. 28, Kobunshi Gousei (Polymer Synthesis) p 357 (Maruzen). Then, a chloromethyl group was introduced into the polysulfone (3-1) by chloromethylation method (which is disclosed in Journal of Polymer Science: Part A: Polymer Chemistry, Vol. 39, 2943-2950, 2001). The chloromethylaized polysulfone was reacted with tetrafluoro-2-(tetrafluoro-2-iodoethoxy)ethane sulfonylfluoride by ATRA method. The obtained polymer is film-formed by a cast method, and then was stirred in methanol solution of 1 mol/l of NaOH for 5 hours to give the following sulfonated polysulfone film.

The ion conductivity of the obtained film was measured according to Journal of the Electrochemical Society vol. 143, No. 4, PP 1254-1259 (1996). The above-described solid electrolyte film was cut out to length of 2 cm and width of 1 cm, which was inserted in a conductivity cell described in Journal of Membrane Science vol. 219, pp 123-136 (2003). Then, the measurement was carried out, while using a combination of Model 1480 and Model 1255B manufactured by Solartron as an impedance analyzer, by an alternating-current impedance method at 80° C. and at 90% relative humidity. The ion conductivity was calculated according to the following formula 1.

Ion conductivity=(Distance between Measuring Terminals)/(Resistance×Film Thickness×Film Width)

The obtained result is listed in Table 1.

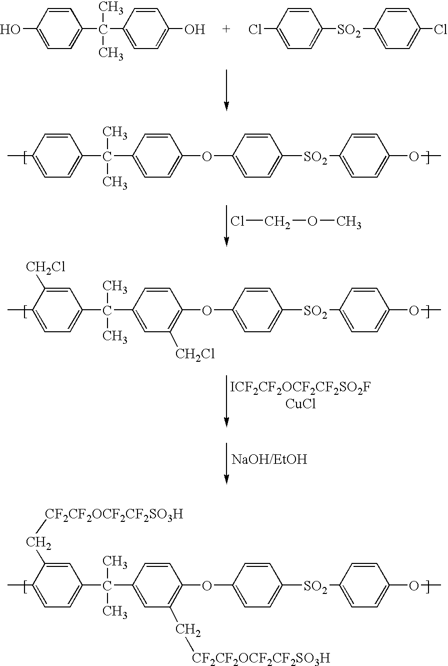

### Example 2

Chloromethylaized polysulfone was synthesized in accordance with Example 1. The chloromethylaized polysulfone was reacted with alcohol sulfonate by Williamson-ether synthetic method in accordance with the following scheme. The obtained polymer is film-formed by a cast method, and then was dipped in 1 mol/l HCl overnight to carry out salt exchange to give a sulfonated polysulfone film.

The ion conductivity of the obtained film was measured in the same was as in Example 1. The measure result is listed in Table 1.

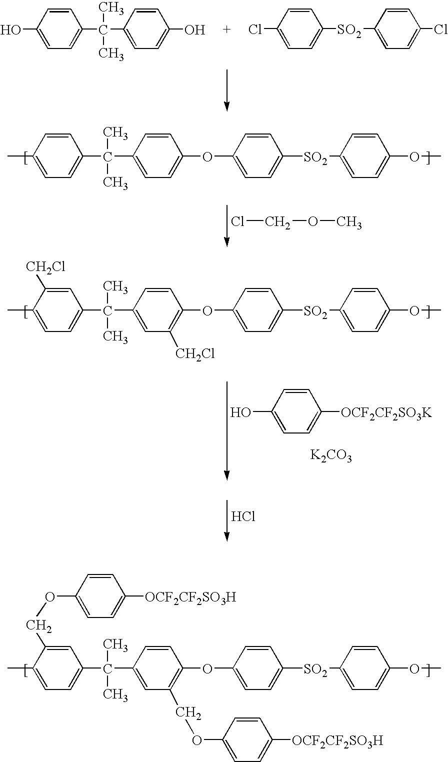

### Example 3

Chloromethylaized polysulfone was synthesized in accordance with Example 1. The chloromethylaized polysulfone was reacted with 3-mercapto-1-difluoro-1-propane sodium sulfonate. The obtained polymer is film-formed by a cast method, and then was dipped in 1 mol/l HCl overnight to carry out salt exchange to give a sulfonated polysulfone film.

The ion conductivity of the obtained film was measured in the same was as in Example 1. The measure result is listed in Table 1.

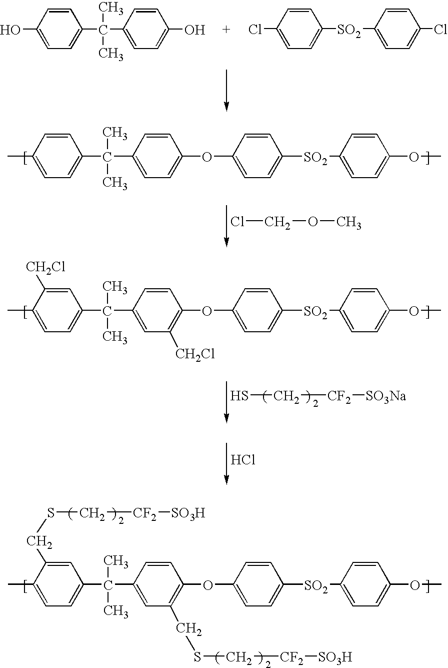

### Example 4

Chloromethylaized polysulfone was synthesized in accordance with Example 1. The chloromethylaized polysulfone was reacted with 3-mercapto-1,2-difluoro-1-propane sodium sulfonate. The obtained polymer is film-formed by a cast method, and then was dipped in 1 mol/l HCl overnight to carry out salt exchange to give a sulfonated polysulfone film.

The ion conductivity of the obtained film was measured in the same was as in Example 1. The measure result is listed in Table 1.

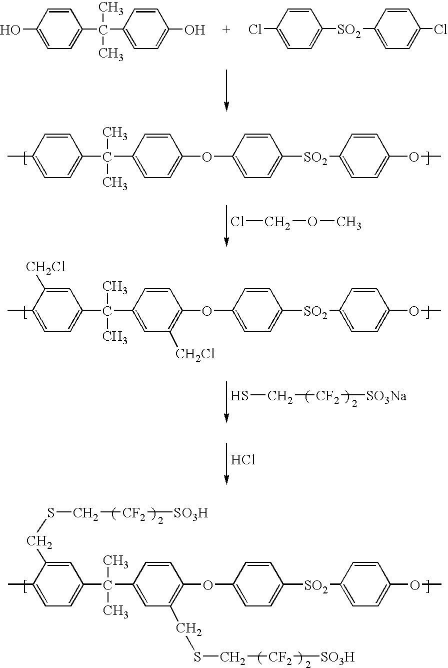

### Example 5

Chloromethylaized polysulfone was synthesized in accordance with Example 1. The chloromethylaized polysulfone was reacted with tetrafluoro-1,2-oxathiethane-2,2-dioxide. The obtained polymer is film-formed by a cast method, and then was dipped and reacted in 2 mol/l Sulfuric acid at 60° C. to give a sulfonated polysulfone film.

The ion conductivity of the obtained film was measured in the same was as in Example 1. The measure result is listed in Table 1.

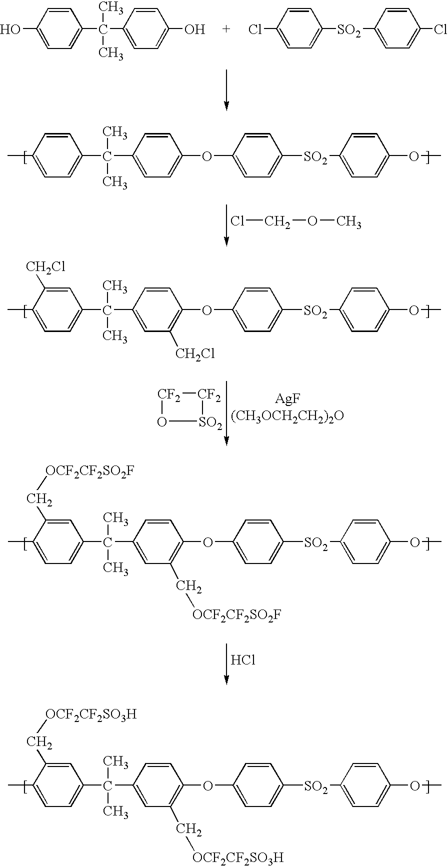

### Comparative Example 1

### Sulfonated Polysulfone

Polysulfone (reagent of Aldrich Company) was sulfonated with concentrated sulfuric acid to give a polymer having been introduced with a sulfonic acid group in a biphenyl unit. The obtained sulfonated polymer was film-formed by a cast method, and then was dipped in 1 mol/l HCl overnight to carry out salt exchange to give a sulfonated polysulfone film.

The ion conductivity of the obtained film was measured in the same was as in Example 1. The measure result is listed in Table 1.

### Comparative Example 2

Chloromethylaized polysulfone was synthesized in accordance with Example 1. The chloromethylaized polysulfone was reacted with 3-mercapto-1-propane sodium sulfonate. The obtained polymer is film-formed by a cast method, and then was dipped in 1 mol/l HCl overnight to carry out salt exchange to give a sulfonated polysulfone film.

The ion conductivity of the obtained film was measured in the same was as in Example 1. The measure result is listed in Table 1.

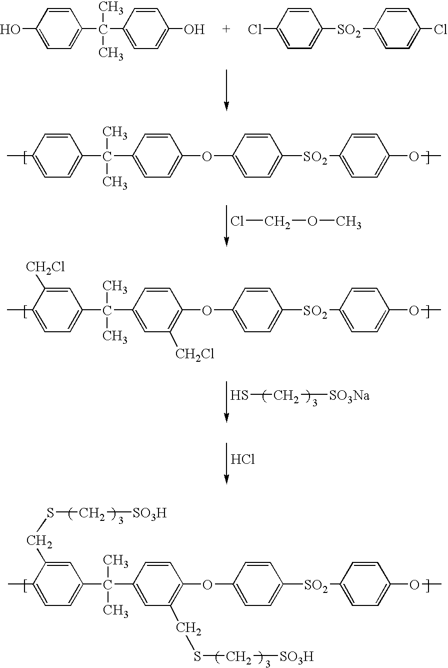

### Comparative Example 3

A polyelectrolyte was synthesized in the same way as in Example 1 of JP-A-2005-314452.

TABLE 1

| | Proton conductivity | |
|---|---|---|
| | (S/cm) | Ion exchange capacity (meq/g) |
| Example 1 | 0.20 | 1.34 |
| Example 2 | 0.17 | 1.32 |
| Example 3 | 0.19 | 1.41 |
| Example 4 | 0.19 | 1.37 |
| Example 5 | 0.20 | 1.32 |
| Comparative | 0.09 | 1.10 |
| Example 1 | | |
| Comparative | 0.13 | 1.35 |
| Example 2 | | |
| Comparative | 0.057 | 1.3 |
| Example 3 | | |

It was recognized that the solid electrolyte film of the invention has a high ion conductivity, and that use of the solid electrolyte film as a binder results in a higher cell voltage. The solid electrolyte can be preferably utilized as a proton exchange film and a binder of a fuel cell.

The present disclosure relates to the subject matter contained in Japanese Patent Application No. 173665/2006 filed on Jun. 23, 2006 and Japanese Patent Application No. 080973/2007 filed on Mar. 27, 2007, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A solid electrolyte having an aromatic ring in a main chain, wherein a sulfonic acid group represented by the following formula (1) bonds to the aromatic ring:
Formula (1) 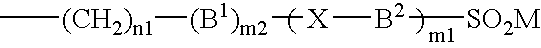
wherein B¹ and B² each independently represents a linking group, at least one of B¹ and B² is a fluorinated alkylene group, X represents a group containing a hetero atom, M represents a cation, m1 represents an integer of 1 or more, m2 represents 0 or 1, and n1 represents an integer of 1 to 20.

2. The solid electrolyte according to claim 1, wherein X in the formula (1) includes an oxygen atom, a sulfur atom or a nitrogen atom.

3. The solid electrolyte according to claim 1, wherein m1 in the formula (1) represents an integer of 1 to 6.

4. The solid electrolyte according to claim 1, wherein the B¹ in the formula (1) is a linking group having 0 to 100 carbon atoms selected from the group consisting of an alkylene group, a halogen substituted alkylene group, an alkyl-substrated alkylene group, an arylene group, a halogen-substituted arylene group, an alkyl-substrated arylene group, an alkenylene group, a halogen-substituted alkenylene group, an alkyl substrated alkenylene group, an alkynylene group, an amide group, an ester group, a sulfonamide group, a sulfonic acid ester group, an ureido group, a sulfonyl group, a sulfinyl group, a thioether group, an ether group, a carbonyl group, a heteryllene group, and a group constituted by combining 2 or more of these.

5. The solid electrolyte according to claim 1, wherein the B² in the formula (1) is a linking group having 0 to 100 carbon atoms selected from the group consisting of a halogen-substituted alkylene group, a halogen substituted arylene group, a halogen substituted alkenylene group, and a group constituted by combining 2 or more of these.

6. The solid electrolyte according to claim 1, wherein the main chain comprises at least one type of repeating unit represented by the following formula (2):
—R¹—X— Formula (2)
wherein R¹ represents any one of structures represented by formulae (6)-(25) below: 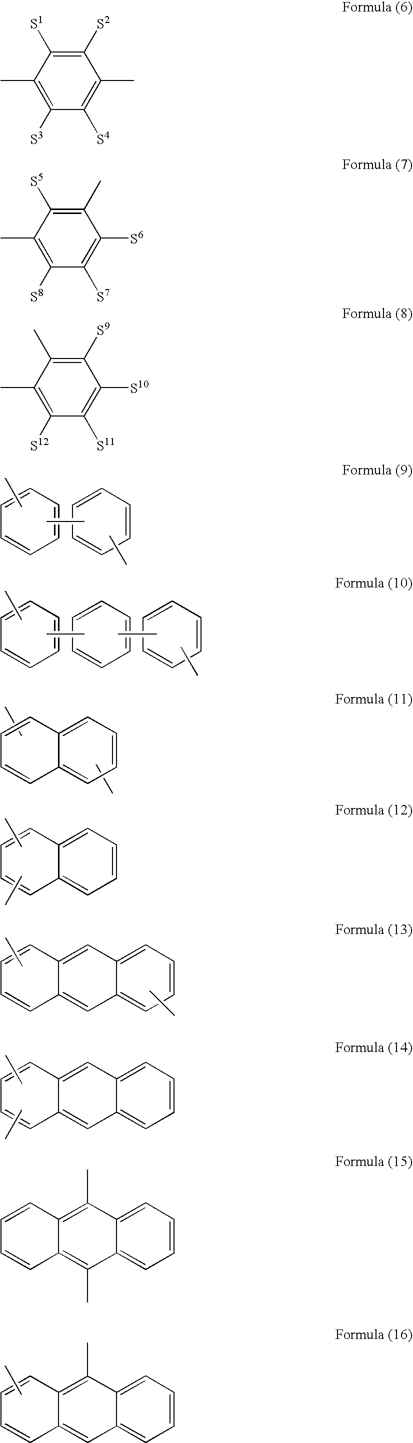 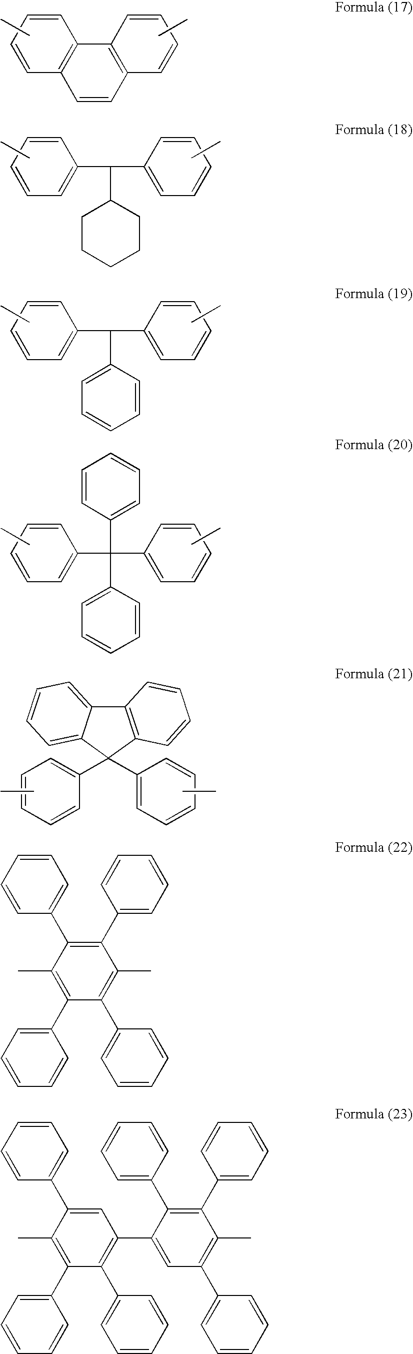 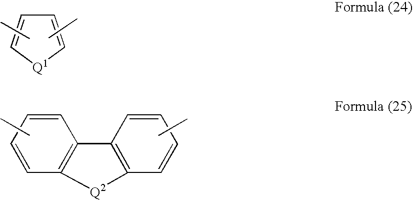
wherein S¹-S¹² in the formulae (6)-(8) each independently represents a hydrogen atom or a substitution group; Q¹ in the formula (24) represents —O— or —S—; and Q² in the formula (25) represents —O—, —CH₂—, —CO— or —NH₂—; X represents a single bond, —C(R⁵R⁶)—, —O—, —S—, —CO—, —SO— —SO₂—, or a combination of 2 or more of these, wherein R⁵ and R⁶ each independently represents a hydrogen atom, an alkyl group, an alkenyl group, an aryl group or a halogen-substituted alkyl group.

7. The solid electrolyte according to claim 1, wherein the solid electrolyte is in the form of a film.

8. A membrane and electrode assembly comprising the solid electrolyte as described in claim 7 and a gas diffusion electrode consisting of a pair of electrodes sandwiching the solid electrolyte therebetween.

9. The membrane and electrode assembly according to claim 8, wherein the gas diffusion electrode is an electrode in which a fine particle of catalyst metal is carried on the surface of a conductive material comprising a carbon material by a binder.

10. The membrane and electrode assembly according to claim 9, wherein the binder includes the solid electrolyte described in claim 1.

11. A fuel cell including the membrane and electrode assembly to claim 8.

12. The fuel cell of claim 11 further including a pair of gas impermeable separators that are arranged so as to sandwich the gas diffusion electrode.

13. The fuel cell of claim 12 further including a pair of current collectors arranged between the solid electrolyte and the separator.
